(19) United States
(12) Patent Application Publication
(10) Pub. No.: US 2022/0051552 A1
(43) Pub. Date: Feb. 17, 2022

(54) Systems and Methods for Multi-Point Check-In Communication and Processing

(71) Applicant: BI Incorporated, Boulder, CO (US)

(72) Inventor: Dustin Pettit, Boulder, CO (US)

(73) Assignee: BI Incorporated, Boulder, CO (US)

(21) Appl. No.: 16/995,248

(22) Filed: Aug. 17, 2020

(51) Int. Cl. G08B 25/08; G08B 21/02; G08B 27/00; H04W 4/80

(52) U.S. Cl. CPC G08B 25/08; G08B 21/02; H04W 4/80; G08B 27/005; G08B 27/006

(57) ABSTRACT

Various embodiments provide systems and methods for providing check-in services for monitored individuals.

### BACKGROUND OF THE INVENTION

Various embodiments provide systems and methods for providing check-in services for monitored individuals.

Large numbers of individuals are currently monitored as part of parole requirements or other requirements. Such monitoring allows a monitoring agency to determine whether the individual is engaging in acceptable patterns of behavior, and where an unacceptable behavior is identified to stop such behavior going forward.

Thus, there exists a need in the art for more advanced approaches, devices and systems for monitoring.

### BRIEF SUMMARY OF THE INVENTION

Various embodiments provide systems and methods for providing check-in services for monitored individuals.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIG. 1a is a block diagram illustrating a hybrid monitoring system including both a user attached monitor device and a user detached monitor device in accordance with various embodiments;

FIG. 1b is a block diagram of a user detached monitor device usable in accordance with one or more embodiments;

FIG. 1c is a block diagram of a user attached monitor device including a local communication link in accordance with some embodiments;

FIG. 1d shows a user attached monitor device with an attachment element for attaching the user attached monitor device to a limb of an individual in accordance with some embodiments;

FIG. 2 is a flow diagram showing a method for complying with a check-in schedule using a user attached monitor devices as the check-in initiator in accordance with various embodiments;

FIG. 3 is a flow diagram showing a method for complying with a check-in schedule using a user attached monitor devices as the check-in initiator in accordance with various embodiments; and

FIG. 4 is a flow diagram showing a method in accordance with some embodiments for processing check-in messages.

### DETAILED DESCRIPTION OF THE INVENTION

Various embodiments provide systems and methods for providing check-in services for monitored individuals.

It has been found that returning offenders to society after being locked up in a secure facility with little if any control of their day to day activities is often unsuccessful. It is often helpful to have, for example, a parole officer monitors their movements and activities for a period of time as they reenter society. In some cases, the parole officer is aided by a tracking device attached to the individual being monitored. However, this is costly as a parole officer must be significantly involved in monitoring and responding to situations. Some embodiments disclosed herein reduce the interaction between the tracking device and the parole officer.

Further, it has been found that once a monitoring term has been completed and a monitored individual has been fully released into society without oversight, the chances that the individual will re-engage in problematic behavior is high. Various embodiments disclosed herein provides tools and devices that continue to support the individual as they transition away from the active oversight by, for example, a parole officer.

To address the aforementioned concerns, periodic check-ins are used to update the location of the individual being monitored. In some cases, however, such periodic check-ins may be rendered impossible where the monitored individual is outside of the communication range of a monitor device attached to the monitored individual (i.e., a user attached monitor device). In such cases, a check-in may be delayed until the monitored individual moves within communication distance, or altogether missed. In such situations, it is often unknown whether the assigned monitoring individual (e.g., a parole officer) should react by sending police or other more active monitoring personnel to visit the individual, or should just wait until more information is available. In some embodiments, previous check-in information may be gathered to aid in making a determination as to whether to react immediately or wait.

Some embodiments provide monitoring systems that include a user attached monitor device. The user attached monitor device includes: a strap configured to attached around a limb of a monitored individual; a first communication circuit configured to communicate with a monitor station via a wide area network; a second communication circuit configured to communicate with a user detached monitor device; a processor; and a computer readable medium. The computer readable medium includes non-transitory instructions executable by the processor to: determine that communication with the monitor station via the first communication circuit is not possible; and based upon determining that communication with the monitor station via the first communication circuit is not possible, communicating a communication request to the user attached monitor device via the second communication circuit.

In some instances of the aforementioned embodiments, the second communication circuit is configured to communicate via a local area network. In some cases, the local area network is a Bluetooth™ network. Based upon the disclosure provided herein, one of ordinary skill in the art will recognize other local area networks that may be used in relation to different embodiments. In various instances of the aforementioned embodiments, the first communication circuit is configured to communicate via a wide area communication network including at least one of: a WiFi access point and a cellular telephone network tower. In one or more instances of the aforementioned embodiments, the first communication circuit is configured to communicate via a WiFi access point and a cellular telephone network tower, and determining that communication with the monitor station via the first communication circuit is not possible includes: determining that communication with the monitor station via the cellular telephone network tower is not possible; and determining that communication with the monitor station via the WiFi access point is not possible.

In various instances of the aforementioned embodiments where the processor is a first processor and the computer readable medium is a first computer readable medium, and the systems may further include the user detached monitor device. The user detached monitor device includes: a second processor; and a second computer readable medium including instructions executable by the second processor to communicate at least a portion of the communication request to the monitor station. In some cases, the communication request includes a location of the user attached monitor device. In some such cases, the communication request may further include a prior no-communication error indicating a reason for a prior failure to communicate with the monitor station.

In some instances of the aforementioned embodiments the computer readable medium further includes a check-in schedule, and wherein the instructions are further executable by the processor to: access the check-in schedule; and start a check-in process based upon the check-in schedule that includes determining that communication with the monitor station via the first communication circuit is not possible.

Other embodiments provide methods for check-in communicating in a monitoring system. The methods include: preparing a data set including a location of a user attached monitor device attached to a monitored individual; determining that communication to a monitor station is not possible using a first communication circuit of the user attached monitor device, wherein the first communication circuit is configured to communicate via a wide area network; and based at least in part on determining that communication to the monitor station is not possible using the first communication circuit, transmitting a communication request to a user detached monitor device via a second communication circuit configured to communicate via a local area network, wherein the communication request includes the data set.

In some instances of the aforementioned embodiments, the user detached monitor device is a cellular telephone associated with the monitored individual. In some cases, the local area network is a Bluetooth™ network. Based upon the disclosure provided herein, one of ordinary skill in the art will recognize other local area networks that may be used in relation to different embodiments.

In various instances of the aforementioned embodiments, the methods further include: receiving the communication request at the user detached monitor device; and communicating at least the data set to the monitor station by the user detached monitor device. In some instances of the aforementioned embodiments, the first communication circuit is configured to communicate via a wide area communication network including at least one of: a WiFi access point and a cellular telephone network tower. In one or more instances of the aforementioned embodiments, the first communication circuit is configured to communicate via a WiFi access point and a cellular telephone network tower, and determining that communication with the monitor station via the first communication circuit is not possible includes: determining that communication with the monitor station via the cellular telephone network tower is not possible; and determining that communication with the monitor station via the WiFi access point is not possible.

In various instances of the aforementioned embodiments, the methods further include: accessing a check-in schedule; and starting a check-in process based upon the check-in schedule. The check-in process includes: preparing the data set; and determining that communication with the monitor station via the first communication circuit is not possible.

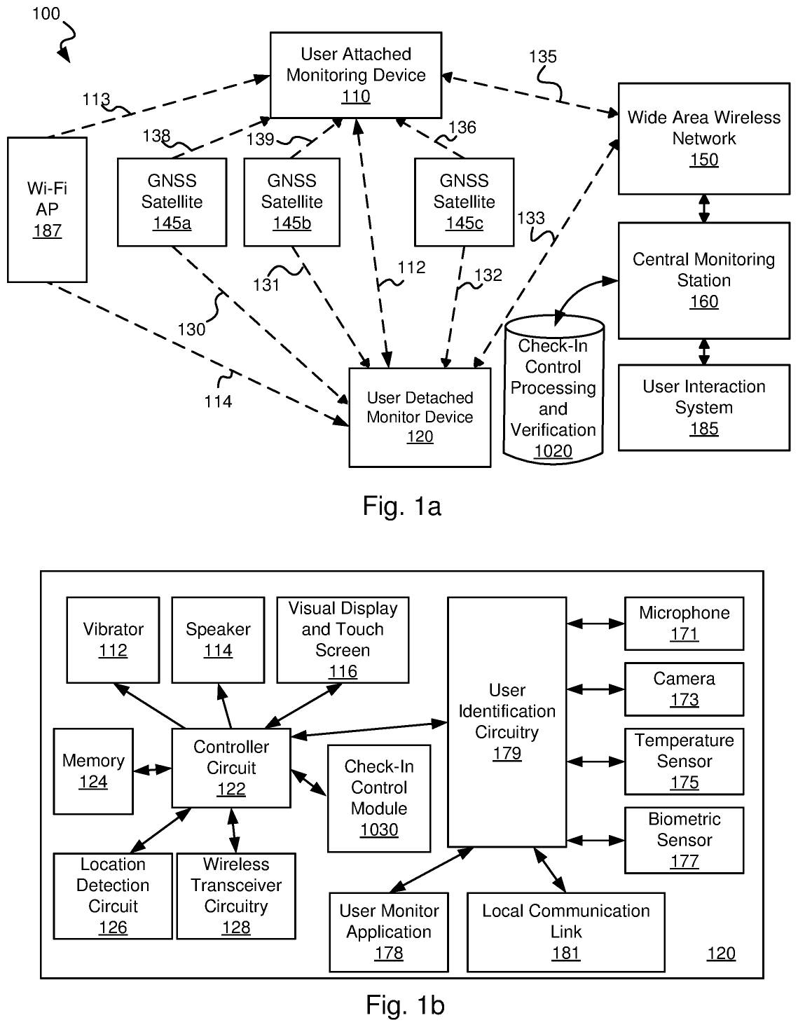

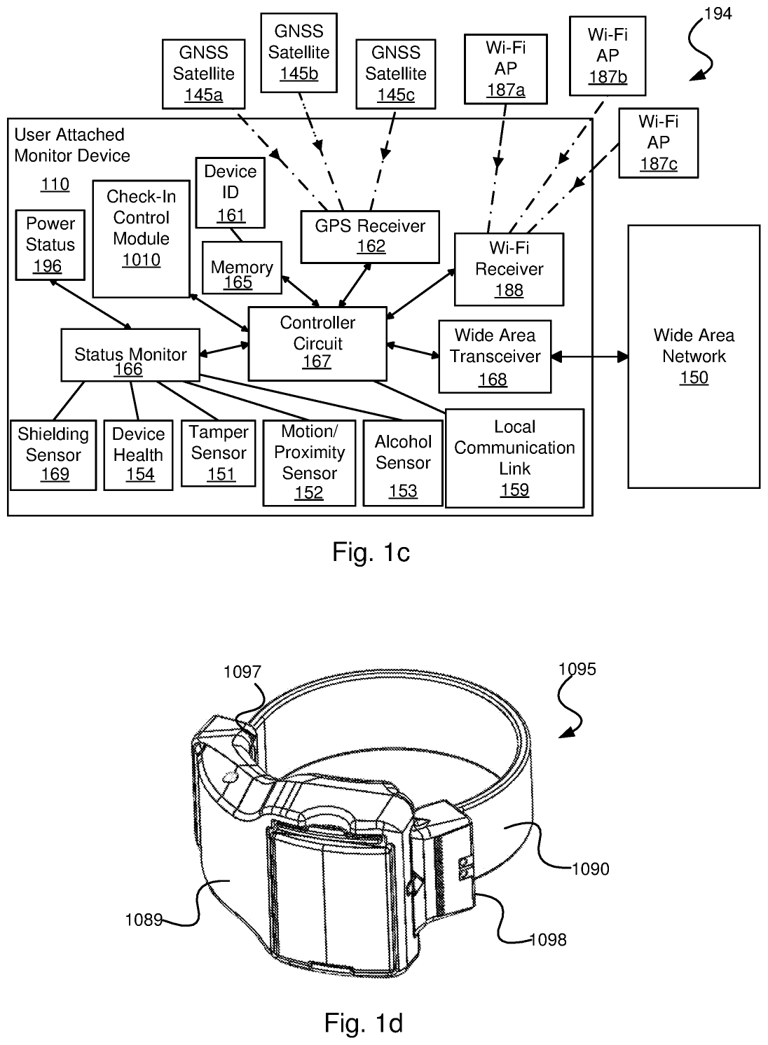

Turning to FIG. 1a, a block diagram illustrates a hybrid monitoring system 100 including both a user attached monitor device 110 and a user detached monitor device 120 in accordance with various embodiments. A local communication link 112 allows for communication between user attached monitor device 110 and user detached monitor device 120. Local communication link 112 may be any communication link that is capable of transferring information or otherwise communicating between two devices within a relatively short distance of each other. In some cases, for example, local communication link 112 may be a Bluetooth™ communication link. In other examples, local communication link 112 may be a line of sight infrared communication link. As yet other examples, local communication link 112 may be a WiFi communication link. Based upon the disclosure provided herein, one of ordinary skill in the art will recognize a variety of communication protocols and/or media that may be used to implement local communication link 112.

User detached monitor device 120 is portable, and may be any device that is recognized as being used by or assigned to an individual being monitored, but is not physically attached to the individual being monitored by a tamper evident attaching device. User detached monitor device 120 may be, but is not limited to, a cellular telephone capable of communication with user attached monitor device 110 via local communication link 112. In contrast, user attached monitor device 110 is attached to the individual being monitored using a tamper evident attaching device like a strap. User attached monitor device 110 may be, but is not limited to, a tracking device that is attached around the limb of an individual and includes indicators to monitor whether the device has been removed from the individual or otherwise tampered. Hybrid monitoring system 100 further includes a central monitoring station 160 wirelessly coupled to user attached monitor device 110 and user detached monitor device 120 via one or more wireless wide area (e.g., cellular telephone network, Internet via a Wi-Fi access point, or the like) communication networks 150.

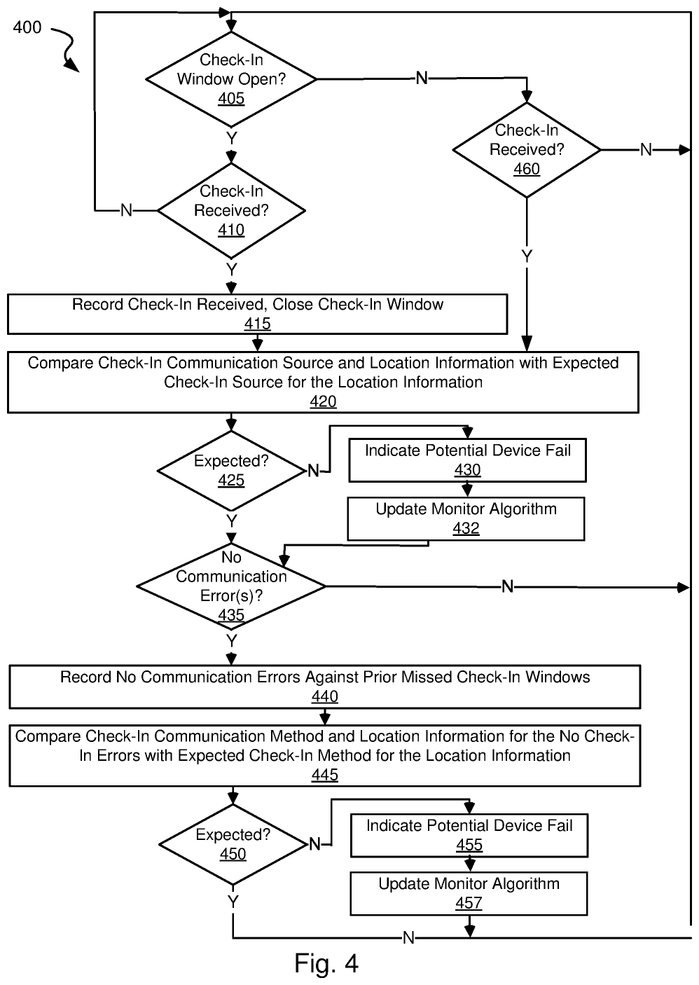

In some embodiments, central monitoring station 160 is communicably coupled to a computer readable medium 1020 that includes check-in control processing and verification instructions executable by a processor of central monitoring station 160 and storage to store a history of check-in information in relation to respective individuals being monitored. In some embodiments, the historical check-in information may be used to discern potential failures of user attached monitor devices 110, user detached monitor device 120, and/or communication networks around user attached monitor devices 110 or user detached monitor device 120. In some cases, a learning algorithm is used to update likelihoods of respective device and/or network failures. One such approach for discerning potential failures of user attached monitor devices 110, user detached monitor device 120, and/or communication networks around user attached monitor devices 110 or user detached monitor device 120, and updating likelihoods of respective device and/or network failures is discussed below in relation to FIG. 4. Central monitoring station 160 stores data received from one or both of user attached monitor device 110 and/or user detached monitor device 120.

User detached monitor device 120 includes a location sensor that senses the location of the device and generates a location data. For example, when user detached monitor device 120 is capable of receiving wireless global navigation satellite system (hereinafter “GNSS”) location information 130, 131, 132 from a sufficient number of GPS or GNSS satellites 145 respectively, user detached monitor device 120 may use the received wireless GNSS location information to calculate or otherwise determine the location of user detached monitor device 120. Global positioning system (hereinafter “GPS) is one example of a GNSS location system. While GPS is used in the specific embodiments discussed herein, it is recognized that GPS may be replaced by any type of GNSS system. In some instances, this location includes latitude, longitude, and elevation. It should be noted that other types of earth-based triangulation may be used in accordance with different embodiments of the present invention. For example, other cell phone-based triangulation, UHF band triangulation such as, for example, long range (hereinafter “LoRa”) triangulation signals. Based on the disclosure provided herein, one of ordinary skill in the art will recognize other types of earth-based triangulation that may be used. The location data may comprise one or more of, but is not limited to: global positioning system (“GPS”) data, Assisted GPS (“A-GPS”) data, Advanced Forward Link Trilateration (“AFLT”) data, and/or cell tower triangulation data. Where GPS is used, user detached monitor device 120 receives location information from three or more GPS satellites 145a, 145b, 145c via respective communication links 130, 131, 132. The aforementioned location data is utilized to verify the location of a monitored individual associated with user detached monitor device 120 at various points as more fully discussed below. User detached monitor device 120 is considered “ambiguous” because it is not attached to the monitored individual in a tamper resistant/evident way, but rather is freely severable from the monitored individual and thus could be used or carried by persons other than the monitored individual. Various processes discussed herein mitigate the aforementioned ambiguity to yield a reasonable belief that information derived from user detached monitor device 120 corresponds to the monitored individual.

In normal operation where communication is available via wireless link 133, the location data and/or other data gathered by user detached monitor device 120 is wirelessly transmitted to central monitoring station 160 via wide area wireless network 150 accessed via a wireless link 133. Alternatively, where transmission is not possible via wireless link 133, transmission may occur via a wireless link 135 using user attached monitor device 110 as an intermediary under control of a check-in control module 1030 as more fully described below. Central monitoring station 160 may be any location, device or system where the location data is received, including by way of non-limiting example: a cellular/smart phone, an email processing server, a website processing server, a network database server, and/or a processor-controlled memory device. The location data is stored by central monitoring station 160 and is retrievable therefrom by a monitor, such as a parent, guardian, parole officer, court liaison, spouse, friend, police officer, or other authorized group or individual. In this manner, monitor is able to respond appropriately to the detected out-of-bounds activity by a user. In some cases, the monitor is able to retrieve the location data via a user interaction system 185 which may be, but is not limited to, a network connected user interface device communicatively coupled via a network to central monitoring station 160 and/or directly to user detached monitor device 120 via wide area wireless network 150.

In some cases, check-in control module 1030 initiates a scheduled check-in process where the check-in is expected from user detached monitor device 120. This includes selecting which check-in method is used (e.g., check-in via WiFi access point accessible to user detached monitor device 120, check-in via cellular telephone network accessible to user detached monitor device 120, or check-in via user attached monitor device 110 acting as an intermediary). One such approach for user detached monitor device 120 initiation of check-in processing is discussed below in relation to FIG. 4.

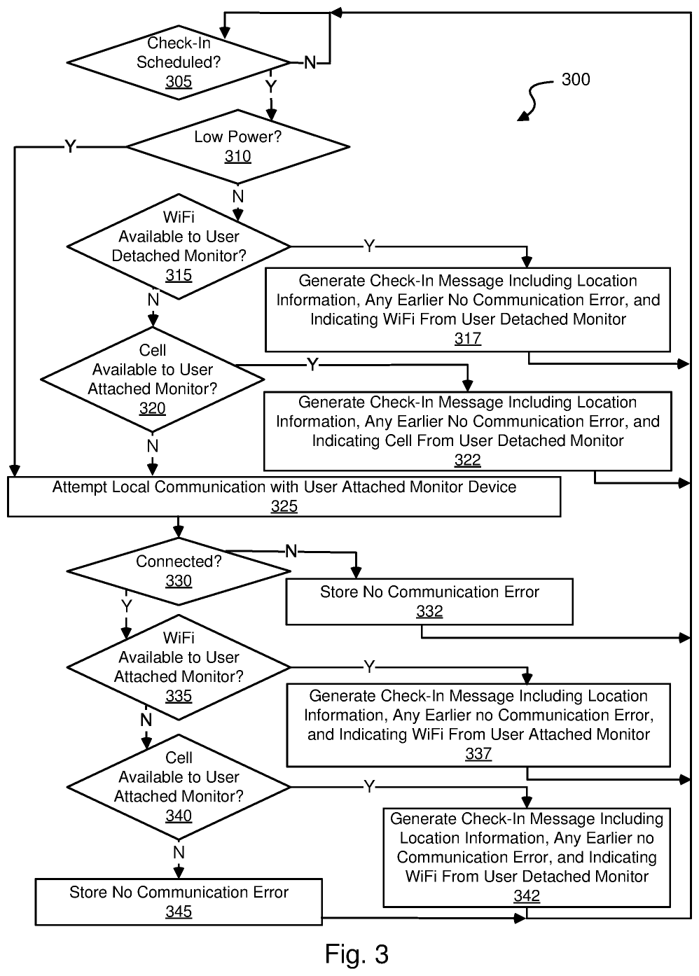

Alternatively, or in addition, check-in control module 1030 facilitates a scheduled check-in process under the direction of user attached monitor device 110 where the check-in is expected from user attached monitor device 110. This includes selecting which check-in method is used (e.g., check-in via WiFi access point accessible to user detached monitor device 120, or check-in via cellular telephone network accessible to user detached monitor device 120). One such approach for user detached monitor device 120 to facilitate check-in processing under the direction of user attached monitor device 110 is discussed below in relation to FIG. 3.

User detached monitor device 120 may further include a user identification sensor operable to generate user identification data for identifying the user in association with the generation of the location data. The user identification data may comprise one or more of: image data, video data, biometric data (e.g. fingerprint, DNA, retinal scan, etc. data), or any other type of data that may be used to verify the identity of the user at or near the time the location data is generated. And the user identification sensor may comprise one or more of: a camera, microphone, heat sensor, biometric data sensor, or any other type of device capable of sensing/generating the aforementioned types of user identification data.

The user identification data is wirelessly transmitted in association with the location data and an indication of the method of communication to central monitoring station 160 via a wireless transmitter communicatively coupled to the user identification sensor. The user identification data is stored in association with the location data by central monitoring station 160 and is retrievable therefrom by a monitor, such as a parent, guardian, parole officer, court liaison, spouse, friend, police officer, or other authorized group or individual. Preferably, the monitor is able to retrieve the location data via a network connected user interface device communicatively coupled—via the network—to central monitoring station 160 and/or to user detached monitor device 120. The location data may be transmitted to central monitoring station 160 independent of the user identification data, for example, during a periodic check-in with central monitoring system 160.

User detached monitor device 120 may further comprise a memory communicatively coupled to a control unit—which is also communicatively coupled to the location sensor, the identification sensor and the wireless transceiver—for controlling the operations thereof in accordance with the functionalities described herein. The memory may include non-transient instructions (e.g., software of firmware-based instructions) executable by the control unit to perform and/or enable various functions associated with user detached monitor device 120. As user detached monitor device 120 is portable, each of the components may be located within, immediately adjacent to, or exposed without, a device housing whose dimensions are such that user detached monitor device 120 as a whole may be discretely carried by the user, for example, within a pocket or small purse. User detached monitor device 120 may include a Wi-Fi transceiver capable of receiving information from one or more Wi-Fi access points 187 that can be used to discern location via a Wi-Fi communication link 114.

Central monitoring station 160 may include a server supported website, which may be supported by a server system comprising one or more physical servers, each having a processor, a memory, an operating system, input/output interfaces, and network interfaces, all known in the art, coupled to the network. The server supported website comprises one or more interactive web portals through which the monitor may monitor the location of the user in accordance with the described embodiments. In particular, the interactive web portals may enable the monitor to retrieve the location and user identification data of one or more users, set or modify ‘check-in’ schedules, and/or set or modify preferences. The interactive web portals are accessible via a personal computing device, such as for example, a home computer, laptop, tablet, and/or smart phone.

In some embodiments, the server supported website comprises a mobile website accessible via a software application on a mobile device (e.g. smart phone). The mobile website may be a modified version of the server supported website with limited or additional capabilities suited for mobile location monitoring.

User attached monitor device 110 includes a location sensor that senses the location of the device and generates a location data. For example, when user attached monitor device 110 is capable of receiving wireless global navigation satellite system (hereinafter “GNSS”) location information 136, 138, 139 from a sufficient number of GPS or GNSS satellites 145 respectively, user attached monitor device may use the received wireless GNSS location information to calculate or otherwise determine the location of human subject 110. Global positioning system (hereinafter “GPS) is one example of a GNSS location system. While GPS is used in the specific embodiments discussed herein, it is recognized that GPS may be replaced by any type of GNSS system. In some instances, this location includes latitude, longitude, and elevation. It should be noted that other types of earth-based triangulation may be used in accordance with different embodiments of the present invention. For example, other cell phone-based triangulation, UHF band triangulation such as, for example, long range (hereinafter “LoRa”) triangulation signals. Based on the disclosure provided herein, one of ordinary skill in the art will recognize other types of earth-based triangulation that may be used. The location data may comprise one or more of, but is not limited to: global positioning system (“GPS”) data, Assisted GPS (“A-GPS”) data, Advanced Forward Link Trilateration (“AFLT”) data, and/or cell tower triangulation data. Where GPS is used, user attached monitor device 110 receives location information from three or more GPS or GNSS satellites 145 via respective communication links 136, 138, 139.

The location data and/or other data gathered by user attached monitor device 110 is wirelessly transmitted to central monitoring station 160 via wide area wireless network 150 accessed via a wireless link 135. Again, central monitoring station 160 may be any location, device or system where the location data is received, including by way of non-limiting example: a cellular/smart phone, an email account, a website, a network database, and a memory device. The location data is stored by central monitoring station 160 and is retrievable by a monitoring person, such as a parent, guardian, parole officer, court liaison, spouse, friend, or other authorized group or individual. In this manner, the monitoring person is able to respond appropriately to the detected out-of-bounds activity by a monitored individual.

In normal operation where communication is available via wireless link 135, the location data and/or other data gathered by user attached monitor device 110 is wirelessly transmitted to central monitoring station 160 via a wide area wireless network 150 accessed via a wireless link 135. Alternatively, where transmission is not possible via wireless link 135, transmission may occur via a wireless link 133 using user detached monitor device 120 as an intermediary under control of a check-in control module 1010 as more fully described below.

In some cases, check-in control module 1010 initiates a scheduled check-in process where the check-in is expected from user attached monitor device 110. This includes selecting which check-in method is used (e.g., check-in via WiFi access point accessible to user attached monitor device 110, check-in via cellular telephone network accessible to user attached monitor device 120, or check-in via user detached monitor device 120 acting as an intermediary). One such approach for user attached monitor device 110 initiation of check-in processing is discussed below in relation to FIG. 3.

Alternatively, or in addition, check-in control module 1010 facilitates a scheduled check-in process under the direction of user detached monitor device 120 where the check-in is expected from user detached monitor device 120. This includes selecting which check-in method is used (e.g., check-in via WiFi access point accessible to user attached monitor device 110, or check-in via cellular telephone network accessible to user attached monitor device 110). One such approach for user attached monitor device 120 to facilitate check-in processing under the direction of user detached monitor device 120 is discussed below in relation to FIG. 4.

User attached monitor device 110 may further comprise a memory communicatively coupled to a control unit—which is also communicatively coupled to the location sensor, the identification sensor and the wireless transceiver—for controlling the operations thereof in accordance with the functionalities described herein. The memory may include non-transient instructions (e.g., software of firmware-based instructions) executable by the control unit to perform and/or enable various functions associated with user attached monitor device 110. User attached monitor device may include a strap which can be wrapped around a limb of the individual being monitored to secure user attached monitor device to the individual. The strap includes one or more tamper circuits and/or sensors that allow for a determination as to whether the device has been removed or otherwise tampered. Examples of a strap and tamper detection circuitry that may be used in relation to various embodiments discussed herein are described in U.S. Pat. No. 9,355,579 entitled “ Methods for Image Based Tamper Detection”, and filed by Buck et al. on Sep. 15, 2014; and US Pat. Pub. No. US 2017-0270778 A1 entitled “Systems and Methods for Improved Monitor Attachment”, and filed by Melton et al. on Mar. 21, 2016. Both of the aforementioned references are incorporated herein by reference for all purposes. Based upon the disclosure provided herein, one of ordinary skill in the art will recognize a variety of straps, tamper circuits, tamper devices, and/or attachment and tamper detection approaches that may be used in relation to various embodiments. User attached monitor device 110 may include a Wi-Fi transceiver capable of receiving information from one or more Wi-Fi access points 187 that may be used to identify location via a Wi-Fi communication link 113.

Turning to FIG. 1b, a block diagram of user detached monitor device 120 is shown in accordance with one or more embodiments. User detached monitor device 120 includes wireless transceiver circuitry 128 that is capable of sending and receiving information via wireless link 133 to/from wide area wireless network 150. Wireless transceiver circuitry 128 may be any circuitry, integrated circuit, and/or processor or controller capable of supporting wireless communication. Such wireless communication may include, but is not limited to, cellular telephone communication, Internet communication via a Wi-Fi access point, or both. In addition, user detached monitor device 120 includes a vibrator 112, a speaker 114, and a visual display and touch screen 116. In some cases, at scheduled times a user of user detached monitor device 120 is alerted of a need to check-in. The schedule of check-in times may be downloaded to a memory 124 by central monitoring station 160 via wireless link 133. The user may be alerted by one or more of: a visual prompt via visual display and touch screen 116, an audio prompt via speaker 114, and a tactile prompt via vibrator 112. Each of vibrator 112, speaker 114, and visual display and touch screen 116 is communicatively coupled to memory 124 and/or a control circuit 122 for controlling the operations thereof. In some cases, control circuit 122 includes a processor. In various cases, control circuit 122 is part of an integrated circuit. In one or more cases, memory 124 is included in an integrated circuit with control circuit 122. In various cases, memory 124 may include non-transient instructions (e.g., software of firmware-based instructions) executable by controller circuit 122 to perform and/or enable various functions associated with user detached monitor device 120. A visual prompt may include, but is not limited to, text, images and/or a combination thereof, or a series of such visual prompts. An audio prompt may include, but is not limited to, one or more different audio prompts, or a series thereof. Each prompt may be stored in memory 124 and retrieved in accordance with the schedule that is also maintained in memory 124. In some embodiments, alerting the user involves a prompt that includes an e-mail or text message generated by central monitoring station 160 (e.g. the server supported website) and transmitted to the e-mail account or cellular phone number corresponding to user detached monitor device 120. In particular embodiments, such a prompt may include a ‘post’ on the user's ‘wall,’ ‘feed,’ or other social networking privilege. In some embodiments, the prompt may comprise an automated or live phone call to the user.

User detached monitor device 120 further includes user identification circuitry 179 capable of gathering user identification information from one or more of a microphone 171, a camera 173, a temperature sensor 175, and/or a biometric sensor 177. In some cases, user identification circuitry 179 is incorporated in an integrated circuit with control circuit 122. Microphone 171 is capable of accurately capturing the sound of a user's voice, camera 173 is capable of accurately capturing images including, for example, an image of the user's face, temperature sensor 175 is capable of accurately capturing an ambient temperature around user detached monitor device 120, and biometric sensor 177 is capable of accurately capturing biometric data about the user including, but not limited to, a thumb print, a retinal scan, or a breath-based alcohol measurement. Based upon the disclosure provided herein, one of ordinary skill in the art will recognize a variety of biometric data and corresponding sensors that may be used in relation to different embodiments. Under the direction of control circuitry 122, user identification circuitry 179 assembles one or more elements of data gathered by microphone 171, a camera 173, a temperature sensor 175, and/or a biometric sensor 177 into a user identification package which is forwarded to central monitoring station 160 via wireless transceiver circuitry 128.

User detached monitor device 120 additionally includes location circuitry 126. Location circuitry 126 may include one or more of, a GPS processing circuit capable of fixing a location of user detached monitor device 120 using GPS data, and/or a cell tower triangulation processing circuit capable of fixing a location of user detached monitor device 120 using cell tower triangulation data. A local communication link 181 controls communication between user detached monitor device 120 and user attached monitor device 110. In some embodiments, local communication link 181 supports a Bluetooth™ communication protocol and is capable of both receiving information from user attached monitor device 110 and transmitting information to user attached monitor device 110. In other embodiments, local communication link 181 supports a Wi-Fi communication protocol and is capable of both receiving information from user attached monitor device 110 and transmitting information to user attached monitor device 110. In some cases, local communication link 181 supports communication in only a receive or transmit direction. Based upon the disclosure provided herein, one of ordinary skill in the art will recognize a variety of communication protocols and information transfer directions that may be supported by local communication link 181 in accordance with different embodiments.

Turning to FIG. 1c, a block diagram 194 of user attached monitor device 110 including a local communication link 159 in accordance with some embodiments. Local communication link 159 controls communication between user attached monitor device 110 and user detached monitor device 120. In some embodiments, local communication link 159 supports a Bluetooth™ communication protocol and is capable of both receiving information from user detached monitor device 120 and transmitting information to user detached monitor device 120. In other embodiments, local communication link 159 supports a Wi-Fi communication protocol and is capable of both receiving information from user detached monitor device 110 and transmitting information to user detached monitor device 110. In some cases, local communication link 159 supports communication in only a receive or transmit direction. Based upon the disclosure provided herein, one of ordinary skill in the art will recognize a variety of communication protocols and information transfer directions that may be supported by local communication link 159 in accordance with different embodiments.

As shown, user attached monitor device 110 includes a device ID 161 that may be maintained in a memory 165, and thus is accessible by a controller circuit 167. Controller circuit 167 is able to interact with a GPS receiver 162 and memory 165 at times for storing and generating records of successively determined GPS locations. Similarly, controller circuit 167 is able to interact with a Wi-Fi receiver 188 and memory 165 at times for storing and generating records of successively determined Wi-Fi access point identifications and signal strength. In some cases, memory 165 may include non-transient instructions (e.g., software of firmware-based instructions) executable by controller circuit 167 to perform and/or enable various functions associated with user attached monitor device 110. As user attached monitor device 110 comes within range of one or more Wi-Fi access points (e.g., Wi-Fi access points 187), Wi-Fi receiver 188 senses the signal provided by the respective Wi-Fi access points, and provides an identification of the respective Wi-Fi access point and a signal strength of the signal received from the Wi-Fi access point to Wi-Fi receiver 188. This information is provided to controller circuit 167 which stores the information to memory 165.

Where user attached monitor device 110 is operating in a standard mode, controller circuit 167 causes an update and reporting of the location of user attached monitor device 110 via a cellular transceiver 168 and a wide area communication network 150 in accordance with a first time period. In contrast, where user attached monitor device 110 is within range of a public Wi-Fi access point, reporting the location of user attached monitor device 110 may be done via the public Wi-Fi access point in place of the cellular communication link. In either case, the check-in message includes an indication of whether the check-in is being effectuated via a cellular network or via a WiFi access point. In cases where, for other than low power reasons, access to a cellular network or to a WiFi access point is not possible for user attached monitor device 110, user attached monitor device 110 passes check-in information to user detached monitor device 120 via local communication link 159 with a request to forward the check-in information. In yet another case where user attached monitor device 110 is operating in a low battery mode, reporting the location of user attached monitor device 110 may be done via user detached monitoring device 120 coupled using local communication link 159.

Which technologies are used to update the location of user attached monitor device 110 may be selected either by default, by programming from a central monitor system (not shown), or based upon scenarios. For example, it may be determined whether sufficient battery power as reported by power status 196 remains in user attached monitor device 110 to support a particular position determination technology. Where insufficient power remains, the particular technology is disabled. In some cases, a maximum cost of resolving location may be set for user attached monitor device 110. For example, resolving Wi-Fi location data may incur a per transaction cost to have a third-party service provider resolve the location information. When a maximum number of resolution requests have been issued, the Wi-Fi position determination technology may be disabled. Further, it may be determined the likelihood that a particular position determination technology will be capable of providing meaningful location information. For example, where user attached monitor device 110 is moved indoors, GPS receiver 162 may be disabled to save power. Alternatively, where the tracking device is traveling at relatively high speeds, the Wi-Fi receiver 188 may be disabled. As yet another example, where cellular phone jamming is occurring, support for cell tower triangulation position determination may be disabled. As yet another example, where GPS jamming is occurring, GPS receiver 162 may be disabled. As yet another example, where user attached monitor device 110 is stationary, the lowest cost (from both a monetary and power standpoint) tracking may be enabled while all other technologies are disabled. Which position determination technologies are used may be based upon which zone a tracking device is located. Some zones may be rich in Wi-Fi access points and in such zones Wi-Fi technology may be used. Otherwise, another technology such as cell tower triangulation or GPS may be used.

Controller circuit 167 of user attached monitor device 110 at times functions in conjunction with cellular transceiver 168 to send and receive data and signals through wide area communication network 150. This link at times is useful for passing information and/or control signals between a central monitoring system (not shown) and user attached monitor device 110. The information transmitted may include, but is not limited to, location information, alcohol information, and information about the status of user attached monitor device 110. Based on the disclosure provided herein, one of ordinary skill in the art will recognize a variety of information that may be transferred via wide area communication network 150.

Various embodiments of user attached monitor device 110 include a variety of sensors capable of determining the status of user attached monitor device 110, and of the individual associated therewith. For example, a status monitor 166 may include one or more of the following subcomponents: power status sensor 196 capable of indicating a power status of user detached monitor device 120. The power status may be expressed, for example as a percentage of battery life remaining. Based upon the disclosure provided herein, one of ordinary skill in the art will recognize a variety of forms in which power status may be expressed. In addition, user attached monitor device 110 includes a set of shielding sensors 169 that are capable of determining whether user attached monitor device 110 is being shielded from receiving GPS signals and/or if GPS jamming is ongoing, a set of device health indicators 154, a tamper sensor 131 capable of determining whether unauthorized access to user attached monitor device 110 has occurred or whether user attached monitor device 110 has been removed from an associated individual being monitored, a motion/proximity sensor 152 capable of determining whether user attached monitor device 110 is moving and/or whether it is within proximity of an individual associated with user detached monitor device 120, and/or an alcohol sensor 153. Such an alcohol sensor may be any alcohol sensor capable of estimating an amount of alcohol in the individual being monitored. Based upon the disclosure provided herein, one of ordinary skill in the art will recognize a variety of alcohol sensors and corresponding alcohol sensing circuitry that may be used in relation to different embodiments. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into user attached monitor device 110 according to various different instances and/or embodiments.

Turning to FIG. 1d, a user attached monitor device 1089 is shown with an example attachment element 1090 connected at opposite ends of user attached monitor device 1089 (i.e., a first end 1097 and a second end 1098). Attachment element 1090 is operable to securely attach a tracking device 1095 (i.e., a combination of user attached monitor device 1089 and attachment element 1090) to a limb of an individual in accordance with some embodiments. In various embodiments, attachment element 1090 includes electrically and/or optically conductive material used to make a conductive connection form first end 1097 to second end 1098 through attachment element 1090 and is used in relation to determining whether user attached monitor device 1089 remains attached and/or has been tampered with. While FIG. 1d shows a strap as an example attachment element, based upon the disclosure provided herein, one of ordinary skill in the art will recognize other types of attachment elements that may be used in relation to different embodiments.

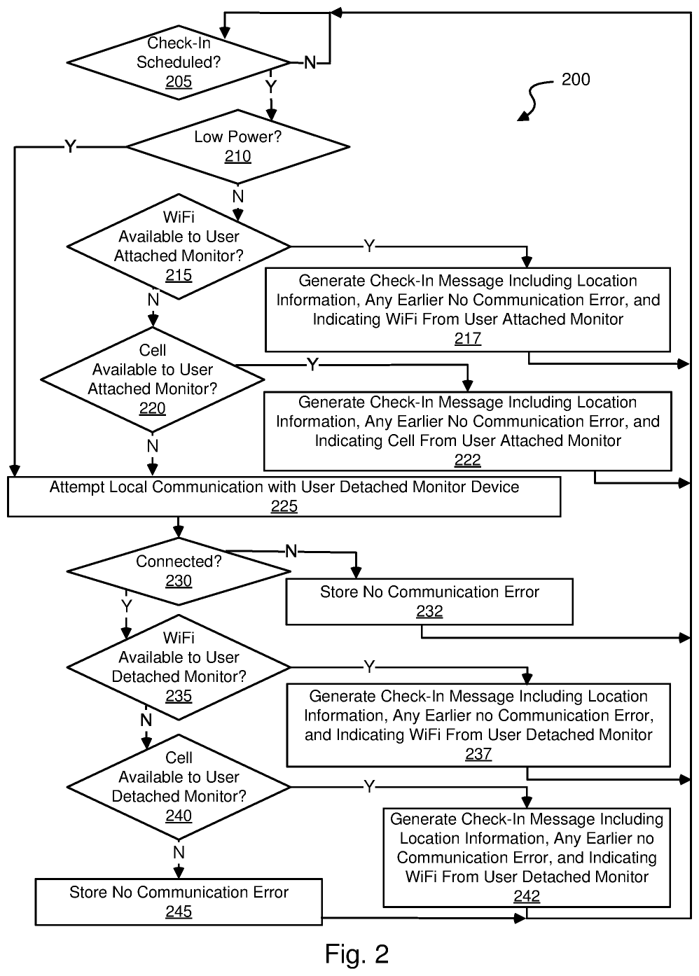

Turning to FIG. 2, a flow diagram 200 shows a method for complying with a check-in schedule using a user attached monitor device 110 as the check-in initiator in accordance with various embodiments. Following flow diagram 200, it is determined whether a check-in is scheduled (block 205). In some embodiments, a user attached monitor device 110 includes a check-in schedule that is maintained in memory 165 and can be updated or otherwise changed remotely by commands received from central monitoring station 160. In some cases, the check-in schedule indicates a number of times during a one-week period when user attached monitor device 110 is expected to check-in with central monitoring station 160. In some cases, the check-in required by the check-in schedule is an automatic check-in where the individual to which user attached monitor device 110 is not aware of an ongoing check-in. In such cases, it is expected that user attached monitor device 110 gather information required as part of the check-in, and transmit the information to central monitoring station. Alternatively, in other cases, the check-in required by the check-in schedule is a manual check-in where the individual to which user attached monitor device 110 is alerted to the check-in requirement and is expected to effectuate the check-in using their cell phone or other means for communicating with the central monitoring station 160 or other indicating check-in recipient. For the purposes of the method of FIG. 2, only automatic check-ins are addressed.

Where a check-in is scheduled (block 205), it is determined whether user attached monitor device 110 is operating in a low power mode where check-ins are expected to be performed by an associated user detached monitor device (block 210). Where user attached monitor device 110 is not in a low power mode where check-ins are expected to be performed by an associated user detached monitor device (block 210), it is determined whether a WiFi access point is accessible to user attached monitor device 110 (block 215). This determination may be done using any approach known in the art for determining whether communications can be performed using a WiFi access point visible to user attached monitor device 110.

Where a WiFi access point is available to user attached monitor device 110 (block 215), a check-in message is generated (block 217). The check-in message includes location information about the location of user attached monitor device 110, and earlier No Communication Errors that have not previously been reported, and indicating the WiFi access point used to send the check-in communication from user attached monitor device 110 to central monitoring station 160. The generated message is then communicated from user attached monitor device 110 to central monitoring station 160 via the available WiFi access point.

Alternatively, where a WiFi access point is not available to user attached monitor device 110 (block 215), it is determined whether a cellular telephone network is available to user attached monitor device 110 (block 220). This determination may be done using any approach known in the art for determining whether communications can be performed using a cellular telephone network visible to user attached monitor device 110.

Where a cellular telephone network is available to user attached monitor device 110 (block 220), a check-in message is generated (block 222). The check-in message includes location information about the location of user attached monitor device 110, and earlier No Communication Errors that have not previously been reported, and indicating the cellular telephone network and/or cellular telephone tower available to user attached monitor device 110 and used to send the check-in communication from user attached monitor device 110 to central monitoring station 160. The generated message is then communicated from user attached monitor device 110 to central monitoring station 160 via the available cellular telephone network.

Alternatively, where a cellular telephone network is not available to user attached monitor device 110 (block 220), local communications are attempted with a user detached monitor device 120 associated with the individual wearing user attached monitor device 110 (block 225). In some embodiments, this local communication attempt is done by local communication link 159 of user attached monitor device 110 that sends a connection request to the local communication link 181 of user detached monitor device 120.

Where user detached monitor device 120 does not indicate an acceptance of communications from user attached monitor device 110 (block 230), a “No Communication Error” is recorded indicating a failure to check-in due to an inability of either user attached monitor device 110 or user detached monitor device 120 to find available communications (block 232). Among other things, the No Communication Error includes an indication of the time of the attempted communication, an indication of one or more communication methods that were attempted, and the location of user attached monitor device 110 at the time of the attempted check-in. This No Communication Error is communicated at a later point when communications become available, and the information that is transmitted may be used by central monitoring station 160 to determine why the failure occurred and/or to predict future check-in failures.

Alternatively, where user detached monitor device 120 indicates an acceptance of communications from user attached monitor device 110 (block 230), it is determined whether a WiFi access point is accessible to user detached monitor device 120 (block 235). This determination may be determined using any approach known in the art for determining whether communications can be performed using a WiFi access point visible to user detached monitor device 120.

Where a WiFi access point is available to user detached monitor device 120 (block 235), a check-in message is generated (block 237). The check-in message includes location information about the location of user attached monitor device 110 and/or user detached monitor device 120, earlier No Communication Errors that have not previously been reported, and indicating the WiFi access point used to send the check-in communication from user detached monitor device 120 to central monitoring station 160. The generated message is then communicated from user detached monitor device 120 to central monitoring station 160 via the available WiFi access point.

Alternatively, where a WiFi access point is not available to user detached monitor device 120 (block 235), it is determined whether a cellular telephone network is available to user detached monitor device 120 (block 240). This determination may be determined using any approach known in the art for determining whether communications can be performed using a cellular telephone network visible to user detached monitor device 120.

Where a cellular telephone network is available to user detached monitor device 120 (block 240), a check-in message is generated (block 242). The check-in message includes location information about the location of user attached monitor device 110 and/or user detached monitor device 120, earlier No Communication Errors that have not previously been reported, and indicating the cellular telephone network and/or cellular telephone tower available to user detached monitor device 120 and used to send the check-in communication from user detached monitor device 120 to central monitoring station 160. The generated message is then communicated from user detached monitor device 120 to central monitoring station 160 via the available cellular telephone network.

Alternatively, where a cellular telephone network is not available to user detached monitor device 120 (block 240), a No Communication Error is recorded indicating a failure to check-in due to an inability of either user attached monitor device 110 or user detached monitor device 120 to find available communications (block 245). Among other things, the No Communication Error includes an indication of the time of the attempted communication, an indication of one or more communication methods that were attempted, and the location of user attached monitor device 110 at the time of the attempted check-in. This No Communication Error is communicated at a later point when communications become available, and the information that is transmitted may be used by central monitoring station 160 to determine why the failure occurred and/or to predict future check-in failures.

Turning to FIG. 3, a flow diagram 300 shows a method for complying with a check-in schedule using a user detached monitor device 120 as the check-in initiator in accordance with various embodiments. The method of flow diagram 300 is similar to that of flow diagram 200 except that the process is primarily driven or initiated by a user detached monitor device 120. Following flow diagram 300, it is determined whether a check-in is scheduled (block 305). In some embodiments, a user detached monitor device 120 includes a check-in schedule that is maintained in memory 124 and can be updated or otherwise changed remotely by commands received from central monitoring station 160. In some cases, the check-in schedule indicates a number of times during a one-week period when user detached monitor device 120 is expected to check-in with central monitoring station 160. In some cases, the check-in required by the check-in schedule is an automatic check-in where the individual to which user detached monitor device 120 is not aware of an ongoing check-in. In such cases, it is expected that user detached monitor device 120 gather information required as part of the check-in, and transmit the information to central monitoring station. Alternatively, in other cases, the check-in required by the check-in schedule is a manual check-in where the individual to which user detached monitor device 120 is alerted to the check-in requirement and is expected to effectuate the check-in using their cell phone or other means for communicating with the central monitoring station 160 or other indicating check-in recipient. For the purposes of the method of FIG. 3, only automatic check-ins are addressed.

In other embodiments, the check-in schedule that is maintained in memory 165 and can be updated or otherwise changed remotely by commands received from central monitoring station 160. In such cases, a check-in requirement indicated by the check-in schedule may be communicated from user attached monitor device 110 to user detached monitor device 120 via a local communication network using local communication link 159 and local communication link 181. Upon receiving the check-in requirement from user attached monitor device 110, user detached monitor device determines that a check-in is scheduled (block 305).

Where a check-in is scheduled (block 305), it is determined whether the user detached monitor device 120 is operating in a low power mode where check-ins are expected to be performed by an associated user attached monitor device 110 (block 310). Where user attached monitor device 110 is not in a low power mode where check-ins are expected to be performed by an associated user detached monitor device (block 310), it is determined whether a WiFi access point is accessible to user detached monitor device 120 (block 315). This determination may be determined using any approach known in the art for determining whether communications can be performed using a WiFi access point visible to user detached monitor device 120.

Where a WiFi access point is available to user detached monitor device 120 (block 315), a check-in message is generated (block 317). The check-in message includes location information about the location of user detached monitor device 120, and earlier No Communication Errors that have not previously been reported, and indicating the WiFi access point used to send the check-in communication from user detached monitor device 120 to central monitoring station 160. The generated message is then communicated from user detached monitor device 120 to central monitoring station 160 via the available WiFi access point.

Alternatively, where a WiFi access point is not available to user detached monitor device 120 (block 315), it is determined whether a cellular telephone network is available to user detached monitor device 120 (block 320). This determination may be determined using any approach known in the art for determining whether communications can be performed using a cellular telephone network visible to user detached monitor device 120.

Where a cellular telephone network is available to user detached monitor device 120 (block 320), a check-in message is generated (block 322). The check-in message includes location information about the location of user detached monitor device 120, and earlier No Communication Errors that have not previously been reported, and indicating the cellular telephone network and/or cellular telephone tower available to user detached monitor device 120 and used to send the check-in communication from user detached monitor device 120 to central monitoring station 160. The generated message is then communicated from user detached monitor device 120 to central monitoring station 160 via the available cellular telephone network.

Alternatively, where a cellular telephone network is not available to user detached monitor device 120 (block 320), local communications are attempted with a user attached monitor device 110 associated with the individual associated with user detached monitor device 120 (block 325). In some embodiments, this local communication attempt is done by local communication link 181 of user detached monitor device 120 that sends a connection request to the local communication link 159 of user attached monitor device 110.

Where user attached monitor device 110 does not indicate an acceptance of communications from user detached monitor device 120 (block 330), a No Communication Error is recorded indicating a failure to check-in due to an inability of either user attached monitor device 110 or user detached monitor device 120 to find available communications (block 332). The No Communication Error includes an indication of the time of the attempted communication and the location of user detached monitor device 120 at the time of the attempted check-in. This No Communication Error is communicated at a later point when communications become available, and the information that is transmitted may be used by central monitoring station 160 to determine why the failure occurred and/or to predict future check-in failures.

Alternatively, where user attached monitor device 110 indicates an acceptance of communications from user detached monitor device 120 (block 330), it is determined whether a WiFi access point is accessible to user attached monitor device 110 (block 335). This determination may be determined using any approach known in the art for determining whether communications can be performed using a WiFi access point visible to user attached monitor device 110.

Where a WiFi access point is available to user attached monitor device 110 (block 335), a check-in message is generated (block 337). The check-in message includes location information about the location of user attached monitor device 110 and/or user detached monitor device 120, earlier No Communication Errors that have not previously been reported, and indicating the WiFi access point used to send the check-in communication from user attached monitor device 110 to central monitoring station 160. The generated message is then communicated from user attached monitor device 110 to central monitoring station 160 via the available WiFi access point.

Alternatively, where a WiFi access point is not available to user attached monitor device 110 (block 335), it is determined whether a cellular telephone network is available to user attached monitor device 110 (block 340). This determination may be done using any approach known in the art for determining whether communications can be performed using a cellular telephone network visible to user attached monitor device 110.

Where a cellular telephone network is available to user attached monitor device 110 (block 340), a check-in message is generated (block 342). The check-in message includes location information about the location of user attached monitor device 110 and/or user detached monitor device 120, earlier No Communication Errors that have not previously been reported, and indicating the cellular telephone network and/or cellular telephone tower available to user attached monitor device 110 and used to send the check-in communication from user attached monitor device 110 to central monitoring station 160. The generated message is then communicated from user attached monitor device 110 to central monitoring station 160 via the available cellular telephone network.

Alternatively, where a cellular telephone network is not available to user attached monitor device 110 (block 340), a No Communication Error is recorded indicating a failure to check-in due to an inability of either user attached monitor device 110 or user detached monitor device 120 to find available communications (block 345). The No Communication Error includes an indication of the time of the attempted communication and the location of user detached monitor device 120 at the time of the attempted check-in. This No Communication Error is communicated at a later point when communications become available, and the information that is transmitted may be used by central monitoring station 160 to determine why the failure occurred and/or to predict future check-in failures.

Turning to FIG. 4, a flow diagram 400 shows a method in accordance with some embodiments for processing check-in messages. Following flow diagram 400, it is determined whether a check-in window is open for a user attached monitor device 110 and/or a user detached monitor device 120 that are associated with a particular individual (block 405). In some embodiments, check-in times are indicated by a check-in schedule that is maintained in a memory of a user attached monitor device 110 and/or a user detached monitor device 120, and the same check-in schedule is maintained in a memory accessible to central monitoring station 160. Central monitoring station 160 allows a window of time around the scheduled check-in time to allow for differences in clocks and/or communication errors. For example, a check-in window may be defined as a period extending from ten (10) minutes before a scheduled check-in to twenty (20) minutes after the scheduled check-in time. Based upon the disclosure provided herein, one of ordinary skill in the art will recognize a variety of check-in window durations and start and stop points that may be used in relation to different embodiments. As discussed below, processing of received check-in messages is slightly different for check-in messages received within a check-in window and those received outside of a check-in window.

Where the time is within a check-in window (block 405), it is determined whether a check-in message has been received (block 410). As check-in messages are received by central monitoring station 160, the identity of the device sending the check-in message (e.g., a user attached monitor device 110 or a user detached monitor device 120) is taken from the received message and matched to a monitored individual. Where the identity of the sending device matches a check-in window time for the individual (block 405) it is found that a check-in message for the monitored individual has been received (block 410). Otherwise, it is found that a check-in message for the monitored individual has not been received (block 410).

Where a check-in message for the monitored individual has been received (block 410), the check-in received for the currently opened check-in window (block 405) is recorded in a database related to the monitored individual and the currently open check-in window is closed (block 415). Alternatively, where a check-in message Is received outside of a check-in window for the monitored individual (block 405 and block 460), block 415 is skipped with processing resuming at block 420.

The check-in message is parsed to retrieve a source of the check-in message and a location of the device responsible for the check-in message. This parsed information is compared with expected information (block 420). The expected information is maintained in check-in control processing and verification 1020 and indicates which device and communication method was expected for the location from which the check-in communication was sent. For example, when the check-in is expected from user attached monitor device 110 associated with the monitored individual using a WiFi access point when user attached monitor device 110 is at X Latitude and Y Longitude, but instead the check-in message was received from user attached monitor device 110 associated with the monitored individual using a cellular telephone network when user attached monitor device 110 is at X′ Latitude and Y′ Longitude, a comparison difference is indicated (block 420). In this case, X′ and Y′ may be a finite distance from X and Y, respectively. As another example, when the check-in is expected from user attached monitor device 110 associated with the monitored individual using a cellular telephone network when user attached monitor device 110 is at X Latitude and Y Longitude, but instead the check-in message was received from user detached monitor device 120 associated with the monitored individual using a cellular telephone network when user attached monitor device 110 or user detached monitor device 120 is at X′ Latitude and Y′ Longitude, a comparison difference is indicated (block 420). As yet another example, when the check-in is expected from user attached monitor device 110 associated with the monitored individual using a WiFi access point when user attached monitor device 110 is at X Latitude and Y Longitude, but instead the check-in message was received from user detached monitor device 120 associated with the monitored individual using a WiFi access point when user attached monitor device 110 or user detached monitor device 120 is at X′ Latitude and Y′ Longitude, a comparison difference is indicated (block 420). Based upon the disclosure provided herein, one of ordinary skill in the art will recognize a variety of differences between received information and expected information in check-in messages that may be flagged in accordance with different embodiments.

Where the information in the check-in message is not as expected (block 425), a potential device fail is indicated based upon the difference indicated (block 430). Based upon the disclosure provided herein, one of ordinary skill in the art will recognize other combinations of received data and expected data that result in different potential device failure indications and/or likelihoods that such potentials are correct.

For example, where user attached monitor device 110 has a latitude and longitude that is very close to a previous check-in, but user attached monitor device 110 is communicating via a cellular network when it previously communicated via a WiFi access point, it potentially indicates: (1) a failure of the WiFi communication circuitry of user attached monitor device 110, (2) a failure of a previously used WiFi access point, (3) a failure of user attached monitor device 110 to select a WiFi access point over a cellular telephone network for communications, or (4) that a seemingly slight difference between a prior reported latitude and longitude (X and Y) of user attached monitor device 110 and the currently reported latitude and longitude (X′ and Y′) of user attached monitor device 110 moves it out of range of the previously used WiFi access point.

As another example, where user attached monitor device 110 has a latitude and longitude that is very close to a previous check-in, but user detached monitor device 120 is communicating via a WiFi access point when communications were previously carried out by user attached monitor device 110 using the same WiFi access point, it potentially indicates: (1) a failure of both WiFi communication circuitry and cellular telephone communication circuitry of user attached monitor device 110, (2) that user attached monitor device 110 is in a low power mode that was not properly reported and/or entered, or (3) that the seemingly small difference between a prior reported latitude and longitude (X and Y) of user attached monitor device 110 and the currently reported latitude and longitude (X′ and Y′) of user attached monitor device 110 moves it out of range of the previously used WiFi access point and any cellular telephone network.

As yet another example, where user attached monitor device 110 has a latitude and longitude that is very close to a previous check-in, but user detached monitor device 120 is communicating via a cellular telephone network when communications were previously carried out by user attached monitor device 110 using the same WiFi access point, it potentially indicates: (1) a failure of the WiFi communication circuitry of user attached monitor device 110, (2) a failure of a previously used WiFi access point, or (3) that a seemingly slight difference between a prior reported latitude and longitude (X and Y) of user attached monitor device 110 and the currently reported latitude and longitude (X′ and Y′) of user attached monitor device 110 moves it out of range of the previously used WiFi access point.

As yet another example, where user attached monitor device 110 has a latitude and longitude that is very close to a previous check-in, but user detached monitor device 120 is communicating via a WiFi access point when communications were previously carried out by user attached monitor device 110 using a cellular telephone network, it potentially indicates: (1) a failure of one or both of WiFi communication circuitry and cellular telephone communication circuitry of user attached monitor device 110, (2) that user attached monitor device 110 is in a low power mode that was not properly reported and/or entered, or (3) that a seemingly slight difference between a prior reported latitude and longitude (X and Y) of user attached monitor device 110 and the currently reported latitude and longitude (X′ and Y′) of user attached monitor device 110 moves it out of range of the previously used WiFi access point.

Various changes to the algorithm controlling expected responses and/or potential device fail indications is updated to reflect the newly received information (block 432). Based upon the disclosure provided herein, one of ordinary skill in the art will recognize various changes to an update monitor algorithm that may be made to increase probabilities that an indicated device failure is correct.

For example, the update monitor algorithm can be updated to reflect the new communication device and/or communication method for the new latitude and longitude (X and Y) of user attached monitor device 110 where the new location is more than a predetermined vector distance from any other previously recorded location latitude and longitude (X′ and Y′) of user attached monitor device 110 to account for situations where no error is occurring, but that the slight difference between a prior reported latitude and longitude (X and Y) of user attached monitor device 110 and the currently reported latitude and longitude (X′ and Y′) of user attached monitor device 110 accounted for the difference in communication. Such a change reduces the possibility of a device failure being indicated due to a slight difference between a prior reported latitude and longitude (X and Y) of user attached monitor device 110 and the currently reported latitude and longitude (X′ and Y′) of user attached monitor device 110 moves it out of range of the previously used WiFi access point.

As another example, check-in data from other devices in the area may be used to discern between a failure of WiFi communication circuitry in a respective user attached monitor device 110 and failure of a WiFi access point. More particularly, where other user attached monitor devices 110 and/or user detached monitor devices 120 use a given WiFi access point when at a latitude and longitude (X and Y), but the current user attached monitor device 110 or user detached monitor device is failing to use WiFi at substantially the same latitude and longitude (X and Y), then the potential that the change is due to a failing of the WiFi access point is decreased and the potential that the change is due to failure of the WiFi circuitry of the user attached monitor device 110 or user detached monitor device 120 is increased. The reverse is also possible where other user attached monitor devices 110 and/or user detached monitor devices 120 also fail to use a given WiFi access point when at a latitude and longitude (X and Y), then the potential that the change is due to a failing of the WiFi access point is increased and the potential that the change is due to failure of the WiFi circuitry of the user attached monitor device 110 or user detached monitor device 120 is decreased.

It is then determined whether the received check-in message included any No Communication Error(s) (block 435). Such No Communication Errors are generated when prior attempts to check-in by user attached monitor device 110 and/or user detached monitor device 120 failed due to an inability to access a network capable of transmitting the check-in message to central monitoring station 160. Among other information, the No Communication Error includes an indication of the time of the attempted communication, an indication of one or more communication methods that were attempted, and the location of user detached monitor device 120 and/or user attached monitor device 110 at the time of the attempted check-in.

Where the received check-in message includes one or more No Communication Errors (block 435), the no communication errors are recorded in the database in relation to prior missed check-in windows (block 440). The attempted check-in communication method (e.g., cellular telephone by user attached monitor device 110, cellular telephone by user detached monitor device 120, WiFi access point by user attached monitor device 110, and/or WiFi access point by user detached monitor device 120) that was tried before the No Communication Error was generated is compared with the expected check-in information for the location where the No Check-in Error was recorded (block 445) and it is determined whether the expected method of communicating the check-in message was used (block 450). The comparison and expectation processing are done similar to that discussed above in relation to block 420 and block 425.

Where something other than what was expected is received (block 450), a potential device failure is indicated (block 455) and the monitor algorithm is updated (block 457). The process of indicating a potential device failure (block 455) and updating the monitor algorithm (block 457) are done similar to that discussed above in relation to block 430 and block 432, respectively.

In conclusion, the present invention provides for novel systems, devices, and methods for monitoring individuals and/or assets. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A monitoring system, the monitoring system comprising:
a user attached monitor device including:
a strap configured to attached around a limb of a monitored individual;
a first communication circuit configured to communicate with a monitor station via a wide area network;
a second communication circuit configured to communicate with a user detached monitor device;
a processor; and
a computer readable medium including instructions executable by the processor to:
determine that communication with the monitor station via the first communication circuit is not possible; and
based upon determining that communication with the monitor station via the first communication circuit is not possible, communicating a communication request to the user attached monitor device via the second communication circuit.

2. The monitoring system of claim 1, wherein the second communication circuit is configured to communicate via a local area network.

3. The monitoring system of claim 2, wherein the local area network is a Bluetooth™ network.

4. The monitoring system of claim 1, wherein the first communication circuit is configured to communicate via a wide area communication network including at least one of: a WiFi access point and a cellular telephone network tower.

5. The monitoring system of claim 1, wherein the first communication circuit is configured to communicate via a WiFi access point and a cellular telephone network tower, and wherein determining that communication with the monitor station via the first communication circuit is not possible includes:
determining that communication with the monitor station via the cellular telephone network tower is not possible; and
determining that communication with the monitor station via the WiFi access point is not possible.

6. The monitoring system of claim 1, wherein the processor is a first processor, wherein the computer readable medium is a first computer readable medium, and wherein the system further comprises:
the user detached monitor device including:
a second processor; and
a second computer readable medium including instructions executable by the second processor to communicate at least a portion of the communication request to the monitor station.

7. The monitoring system of claim 6, wherein the communication request includes a location of the user attached monitor device.

8. The monitoring system of claim 7, wherein the communication request further includes a prior no-communication error indicating a reason for a prior failure to communicate with the monitor station.

9. The monitoring system of claim 1, wherein the computer readable medium further includes a check-in schedule, and wherein the instructions are further executable by the processor to:
access the check-in schedule; and
start a check-in process based upon the check-in schedule that includes determining that communication with the monitor station via the first communication circuit is not possible.

10. A method for check-in communicating in a monitoring system, the method comprising:
preparing a data set including a location of a user attached monitor device attached to a monitored individual;
determining that communication to a monitor station is not possible using a first communication circuit of the user attached monitor device, wherein the first communication circuit is configured to communicate with the monitor station via a wide area network; and
based at least in part on determining that communication to the monitor station is not possible using the first communication circuit, transmitting a communication request to a user detached monitor device via a second communication circuit configured to communicate with the user detached monitor device via a local area network, wherein the communication request includes the data set.

11. The method of claim 10, wherein the user detached monitor device is a cellular telephone associated with the monitored individual.

12. The method of claim 10, wherein the local area network is a Bluetooth™ network.

13. The method of claim 10, the method further comprising:
receiving the communication request at the user detached monitor device; and
communicating at least the data set to the monitor station by the user detached monitor device.

14. The method of claim 10, wherein the first communication circuit is configured to communicate via a wide area communication network including at least one of: a WiFi access point and a cellular telephone network tower.

15. The method of claim 10, wherein the first communication circuit is configured to communicate via a WiFi access point and a cellular telephone network tower, and wherein determining that communication with the monitor station via the first communication circuit is not possible includes:
determining that communication with the monitor station via the cellular telephone network tower is not possible; and
determining that communication with the monitor station via the WiFi access point is not possible.

16. The method of claim 10, wherein the data set further includes a prior no-communication error indicating a reason for a prior failure to communicate with the monitor station.

17. The method of claim 10, the method further comprising:
accessing a check-in schedule; and
starting a check-in process based upon the check-in schedule, wherein the check-in process includes:
preparing the data set; and
determining that communication with the monitor station via the first communication circuit is not possible.

18. A monitoring system, the monitoring system comprising:
a user attached monitor device including:
a strap configured to attached around a limb of a monitored individual;
a first communication circuit configured to communicate with a monitor station;
a second communication circuit configured to communicate with a user detached monitor device;
a processor; and
a computer readable medium including instructions executable by the processor to:
prepare a data set including a location of a user attached monitor device attached to a monitored individual;
determine that communication with the monitor station via a WiFi access point is not possible via the first communication circuit;
determine that communication with the monitor station via a cellular telephone tower is not possible via the first communication circuit; and
based upon determining that communication with the monitor station is not possible via either the WiFi access point or the cellular telephone tower, communicating a communication request to the user attached monitor device via the second communication circuit, wherein the communication request includes the data set.

19. The system of claim 18, wherein the data set further includes a prior no-communication error indicating a reason for a prior failure to communicate with the monitor station.

20. The system of claim 18, wherein the processor is a first processor, wherein the computer readable medium is a first computer readable medium, and wherein the system further comprises:
the user detached monitor device including:
a second processor; and
a second computer readable medium including instructions executable by the second processor to communicate at least the data set to the monitor station.
